(19) United States
(12) Patent Application Publication
(10) Pub. No.: US 2024/0179084 A1
(43) Pub. Date: May 30, 2024

(54) DIGITAL INTERMEDIATE FREQUENCY VECTOR ANALYZER

(71) Applicant: Welkin Sciences, Colorado Springs, CO (US)

(72) Inventor: J. Todd Reinking, Colorado Springs, CO (US)

(21) Appl. No.: 18/521,988

(22) Filed: Nov. 28, 2023

Related U.S. Application Data
(60) Provisional application No. 63/385,066, filed on Nov. 28, 2022.

(51) Int. Cl. H04L 43/50; H04L 43/045

(52) U.S. Cl. CPC H04L 43/50; H04L 43/045

(57) ABSTRACT

Disclosed is a device for monitoring, analyzing, and testing data stream transmissions on a radio signal transport (RST) network for compliance with a transmission and receiving standard. The device includes a computer processor, a management network interface card (NIC), and a primary NIC. The primary NIC is used to connect to the RST network, and is controlled by an application programming interface that operates outside of the device's main operating system. Custom software compatible with the API composes and parses data packets in compliance with the standard. Also disclosed is a method for performing monitoring and analysis of data streams transmitted on an RST network. A method for certifying compliance of a device under test with the standard is also disclosed, as is a method to create a simulated network for testing device transmission and reception of data streams modified by simulated channel effects.

### CROSS-REFERENCE TO RELATED APPLICATIONS

This application claims priority to U.S. Provisional Application No. 63/385,066, filed Nov. 28, 2022, which is hereby incorporated by reference herein in its entirety.

### BACKGROUND

### Field of the Invention

The disclosed invention relates to devices and systems for implementing a Digital Intermediate Frequency Vector Analyzer (DIVA) for testing compliance with DIFI Standard composition and translation of data packets.

### Relevant Background

The Digital Intermediate Frequency Interoperability Standard put forth under the IEEE Industry Standards and Technology Organization, designated IEEE-ISTO 4900-2021 (the “DIFI Standard”), sets out the standard requirements to transmit and receive digitized radio frequency (RF) or Intermediate Frequency (IF) data and corresponding metadata over standard IP networks. The disclosed invention is a system configured to compose and parse DIFI Standard data packets, and is configured to analyze data packets for compliance with the DIFI Standard.

Existing systems for composing and parsing digitized IF and RF data are either non-compliant with the DIFI Standard, or operate too slowly for full DIFI Standard compliance. Existing systems are also incapable of determining compliance with the DIFI Standard for data packet transmission.

Therefore, it is apparent that a need exists for a device and system implementation that fully complies with the DIFI Standard for both reception and transmission of data packets, that can analyze data packets to determine compliance with the DIFI Standard, and simulate and assess causes of data packet non-compliance. The disclosed invention addresses the stated needs.

These and other deficiencies of the prior art are addressed by one or more embodiments of the disclosed invention. Additional advantages and novel features of this invention shall be set forth in part in the description that follows, and in part will become apparent to those skilled in the art upon examination of the following specification or may be learned by the practice of the invention. The advantages of the invention may be realized and attained by means of the instrumentalities, combinations, compositions, and methods particularly pointed out hereafter.

### BRIEF DESCRIPTION OF THE DRAWINGS

Features and objects of the disclosed invention and the manner of attaining them will become more apparent, and the invention itself will be best understood, by reference to the following description of one or more embodiments taken in conjunction with the accompanying drawings and figures imbedded in the text below and attached following this description.

FIG. 1 depicts components of a special purpose computer as used in embodiments of the disclosed invention.

FIG. 2 is a front view of an embodiment of the disclosed invention.

FIG. 3 is a depiction of the DIFI Standard network stack as used in an embodiment of the disclosed invention.

FIG. 4 depicts a graphical user interface showing a Monitor Page, as used in an embodiment of the disclosed invention.

FIG. 5 depicts a graphical user interface showing a Transmit Page, as used in an embodiment of the disclosed invention.

FIGS. 6A and 6B depict a graphical user interface showing a Receive Page, used in an embodiment of the disclosed invention.

FIG. 7 is a block diagram showing a device under test, as used in an embodiment of the disclosed invention.

FIG. 8 is a block diagram showing a simulated network, as used in an embodiment of the disclosed invention.

The Figures depict embodiments of the disclosed invention for purposes of illustration only. One skilled in the art will readily recognize from the following discussion that alternative embodiments of the structures and methods illustrated herein may be employed without departing from the principles of the invention described herein.

### Definitions

IF means intermediate frequency, a frequency to which a carrier wave is shifted as an intermediate step in the transmission or reception of a radio signal.

RF means radio frequency and represents electromagnetic oscillations in the range from around 20,000 cycles per second (kHz) to 300 gigahertz (GHz).

DIFI Standard means the IEEE-ISTO Standard 4900-2021: Digital IF Interoperability Standard Version 1.2 and later versions.

VITA 49.2 Standard means the ANSI/VITA 49.2 standard and later versions, which is part of the VITA Radio Transport group of standards.

IP means Internet Protocol, the communications protocol at the network layer for relaying data across network boundaries.

DIFI information stream, or data stream, means a series of data packets that include context and signal packets, and that together constitute a transmission from a transmission source.

### DESCRIPTION

The disclosed invention relates to systems and methods for implementing a Digital Intermediate Frequency Vector Analyzer (DIVA) that is capable of composing and parsing DIFI Standard compliant data packets, and to test other devices' ability to compose, parse, and transmit data packets in compliance with the DIFI Standard.

The disclosed invention will now be described in detail with reference to several embodiments thereof as illustrated in the accompanying Figures. In the following description, specific details are set forth in order to provide a thorough understanding of embodiments of the disclosed invention. It will be apparent, however, to one skilled in the art that embodiments may be practiced without some or all of these specific details. In other instances, well known process steps and/or structures have not been described in detail in order to not unnecessarily obscure the invention. The features and advantages of embodiments may be better understood with reference to the drawings and discussions that follow.

It should be apparent to those skilled in the art that the described embodiments of the disclosed invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the disclosed invention as defined herein and equivalents thereto. Hence, use of absolute and/or sequential terms, such as, for example, “always,” “will,” “will not,” “shall,” “shall not,” “must,” “must not,” “first,” “initially,” “next,” “subsequently,” “before,” “after,” “lastly,” and “finally,” are not meant to limit the scope of the disclosed invention as the embodiments disclosed herein are merely exemplary.

It will be also understood that when an element is referred to as being “on,” “attached” to, “connected” to, “coupled” with, “contacting”, “mounted” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used to describe one element or feature's relationship to another element(s) or feature(s) as illustrated in the figures. Such spatially relative terms are intended to encompass different orientations of a device in use or operation in addition to the orientation depicted in the figures. For example, if a device in the figures is inverted, elements described as “under,” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

Included in the description are flowcharts depicting examples of the methodology which may be used for AI-guided and conventional algorithmic processes. Each block and combinations of blocks depicted in the flowchart illustrations, can be implemented by computer program instructions. These computer program instructions may be loaded onto a computer, a special purpose hardware-based computer system, or other programmable apparatus to produce a machine such that the executed instructions create means for implementing the functions specified in the flowchart block or blocks. These computer program instructions may also be stored in a computer-readable memory that can direct a computer or other programmable apparatus to function so that the instructions produce an article of manufacture that implements the function specified in the flowchart block or blocks. The computer program instructions may also be loaded onto a computer or other programmable apparatus to cause a series of operational steps to be performed so that the executed instructions provide steps for implementing the functions specified in the flowchart block or blocks.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

### Specialized Computer Hardware

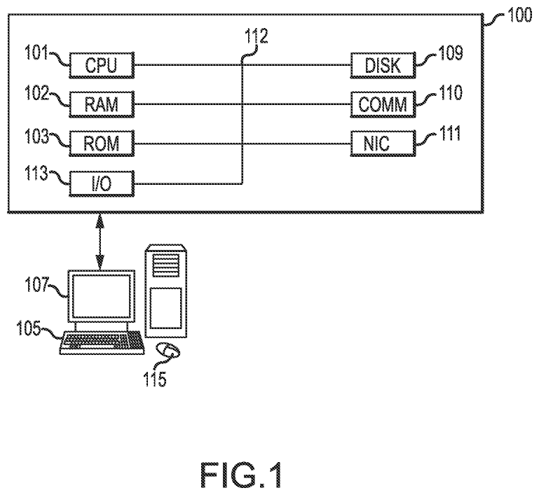

Portions of the disclosed invention may be implemented, at least in part, on a specialized computer system, e.g., a specialized web server. FIG. 1 is a general block diagram of a special-purpose computer system in which software-implemented processes of the disclosed invention may be embodied. As shown, the system 100 comprises one or more central processing unit(s) (CPU) or processor(s) 101 coupled to a random-access memory (RAM) 102, a read-only memory (ROM) 103, a fixed storage device 109 (e.g., hard disk, flash drive), a communication (COMM) port(s) or interface(s) 110, and a dual port high speed network interface card (NIC) 111. The system can be accessed by a network-connected computing device having a keyboard or user interface 105 and a display device 107 (e.g., screen, touchscreen, or monitor). Although not shown separately, a real time system clock is included with the system 100, in a conventional manner.

The CPU 101 comprises a suitable processor for implementing the disclosed invention. The CPU 101 communicates with other components of the system via a bi-directional system bus 112, and any necessary input/output (I/O) controller 113 circuitry and other “glue” logic. The bus, which includes address lines for addressing system memory, provides data transfer between and among the various components. RAM 102 serves as the working memory for the CPU 101. ROM 104 contains the basic I/O system code (BIOS), which is a set of low-level routines in ROM that application programs and the operating systems can use to interact with the hardware, including reading characters from the keyboard, etc. Some embodiments include a graphics processing unit (GPU) (not shown) to add processing capability to the system.

Mass storage devices 109 provide persistent storage on fixed and removable media, such as magnetic, optical, or magnetic-optical storage systems, flash memory, or any other available mass storage technology. The mass storage may be shared on a network, e.g., cloud storage, or it may be a dedicated mass storage device. As shown in FIG. 1, fixed storage 109 stores a body of program instructions and data for directing operation of the computer system, including an operating system, user application programs, driver, and other support files, as well as other data files of all sorts. Typically, the fixed storage 109 serves as the main memory for the system.

In operation, program logic (including that which implements methodology of the disclosed invention described herein) is loaded from fixed storage 109 into the main (RAM) memory 102, for execution by the CPU 101. During operation of the program logic, the system 100 accepts user input from a keyboard, touchscreen, and/or pointing device 115. The user interface 105 permits selection of application programs, entry of keyboard-based input or data, and selection and manipulation of individual data objects displayed on the screen or display device 107. Likewise, the pointing device 115, such as a mouse, track ball, pen device, or a digit in the case of a touch screen, permits selection and manipulation of objects on the display device. In this manner, these input devices support manual user input for any process running on the system. The computer system 100 displays text and/or graphic images and other data on the display device 107.

The system itself communicates with other devices (e.g., DIFI packet processors, other servers, or computers) via a port on the dual port NIC 111 that is connected to a network (e.g., Ethernet network), or via a secondary NIC (not shown). The system may also communicate with local occasionally connected devices (e.g., serial cable-linked devices) via the COMM interface 110, which may include a RS-232 serial port, a Universal Serial Bus (USB) interface, or the like.

The system may be implemented through various networks and their associated communication devices. Such networks may include DIFI packet processors, servers, modems, or computers, such as a gateway computer or application server which may have access to a database. A gateway computer serves as a point of entry into each network and may be coupled to another network by means of a communications link. The gateway may also be directly or indirectly coupled to one or more devices using a communications link, or may be coupled to a storage device such as a data repository or database.

### Digital IF Vector Analyzer

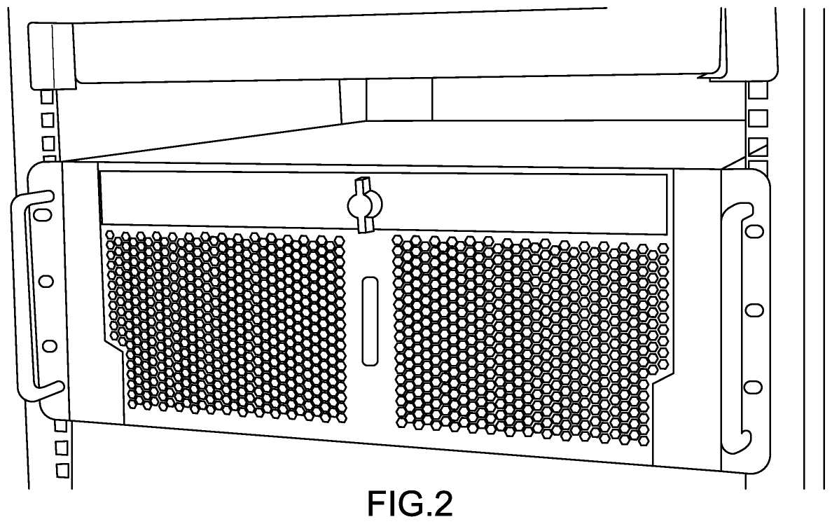

The disclosed Digital Intermediate Frequency Vector Analyzer (DIVA) is a specialized computer platform running custom software. See FIG. 2. DIVA's hardware systems include a two port 100 gigabit Ethernet (GbE) network interface card (NIC) (the RST NIC) to connect to a network used for Radio Signal Transport (RST). Each port of the RST NIC is capable of transmitting or processing Ethernet frames at a rate of 100 gigabits per second. NICs with a faster processing rate capacity may be advantageous and are contemplated. A secondary NIC (the Management NIC) is dedicated to handle user interface communications. DIVA also includes a multi-core CPU for processing DIFI packets and some embodiments use a GPU to provide intensive signal processing.

DIVA is configured to run a Linux operating system (OS), however, DIVA's primary signal packet processing functionality is handled outside of the Linux OS. The RST NIC is controlled using the Data Plane Development Kit (DPDK) software API. The DPDK is an open-source API developed specifically to accelerate sending and receiving Ethernet frames. DIVA primarily uses DPDK to bypass the Linux kernel software network stack, thereby avoiding latency jitter when sending DIFI data packets. DIVA also uses DPDK to manage its multiple CPU cores to reduce latency jitter when sending and receiving packets over the NIC. Latency jitter hampers transmission of radio signal packets, which must be timely for effective transmission.

The system also uses DIVA custom software that is constructed to operate and be compatible with the DPDK API. DIVA custom software is used to compose the DIFI Standard Ethernet packets, while DPDK software is used to handle generic Ethernet frames.

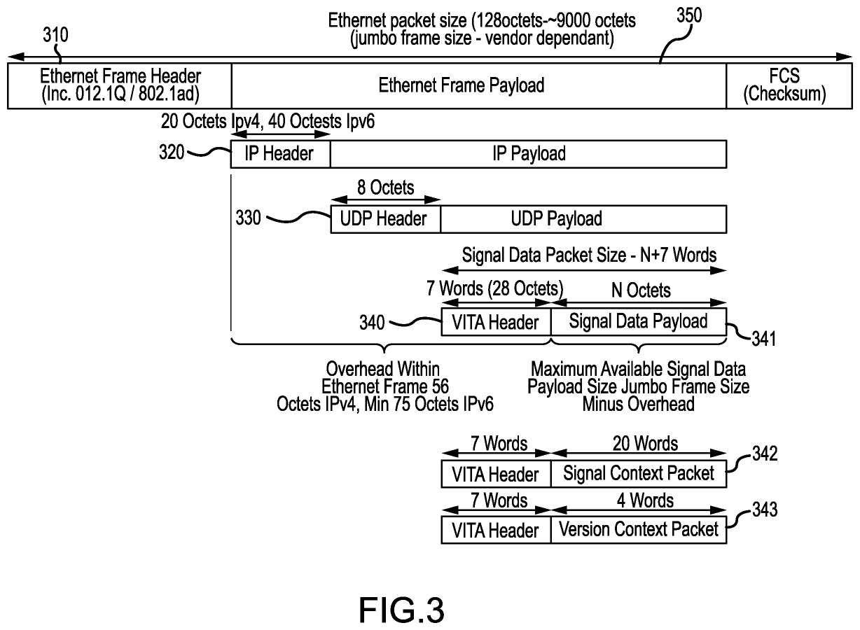

The disclosed system is configured to compose, send, receive, and translate DIFI Standard-compliant packet streams carrying radio signal data. With reference to FIG. 3, the DIFI Standard protocol is designed to work within a network stack that is comprised of an Ethernet frame as the outer most network layer 310, an IP Packet as the second layer 320, and a User Datagram Protocol (UDP) Packet as the third layer 330. The inner-most network layer (The VITA Packet) 340 is a radio signal transport layer compliant with the VITA 49.2 or subsequent standard. There are two DIFI Standard classes of information streams that can be transmitted as the VITA 49.2 layer. The first is Information Class 0x0000 for transporting radio signal data packets 341, and signal context packets 342, and the second is Information Class 0x0001 for carrying version context packets 343. DIVA is designed to transmit and receive data streams from both information classes, namely radio signal 341, signal context 342, and signal version 343 data.

The DIFI Signal Data Packet 341 is a VITA 49.2 compliant packet class that includes a payload of radio signal in-phase (I) and quadrature (Q) samples configured for transport over an RST network. The signal data packet 341 payload is flexible as to the bit depth of samples, as well as the number of samples per packet. The bit depth of the in-phase or quadrature component of the sampled signal may vary from 4 to 16 bits. The number of samples is constrained by the Ethernet frame 310 packet size 350. Namely, the signal packet payload 341 must fit within the remaining space of the Ethernet frame after accounting for overhead transmissions from each layer in the network stack 310, 320, 330, 340. As required by the DIFI Standard, radio signal samples are packed into the payload in a link efficient manner, i.e., no zeros are inserted between samples, and samples are not aligned on byte boundaries. DIVA custom software is written to process all possible configurations of the packet payload, including sample-depth and payload size according to the DIFI Standard.

### DIVA User Interface

User input and management is facilitated by use of a web browser interface accessed through the dedicated Management NIC. The management server port is configured to accept user input, to display monitoring information, and to relay responses to user requests. A system user accesses the management server at a designated IP address and UDP port using a standard web browser such as Firefox, Google Chrome, or Microsoft Edge. Use of the Management NIC, rather than the 100 GbE RST NIC, avoids mixing system management data with signal data. Use of the separate, smaller capacity Management NIC also allows DIVA to connect to a wider variety of networks for purposes of system control.

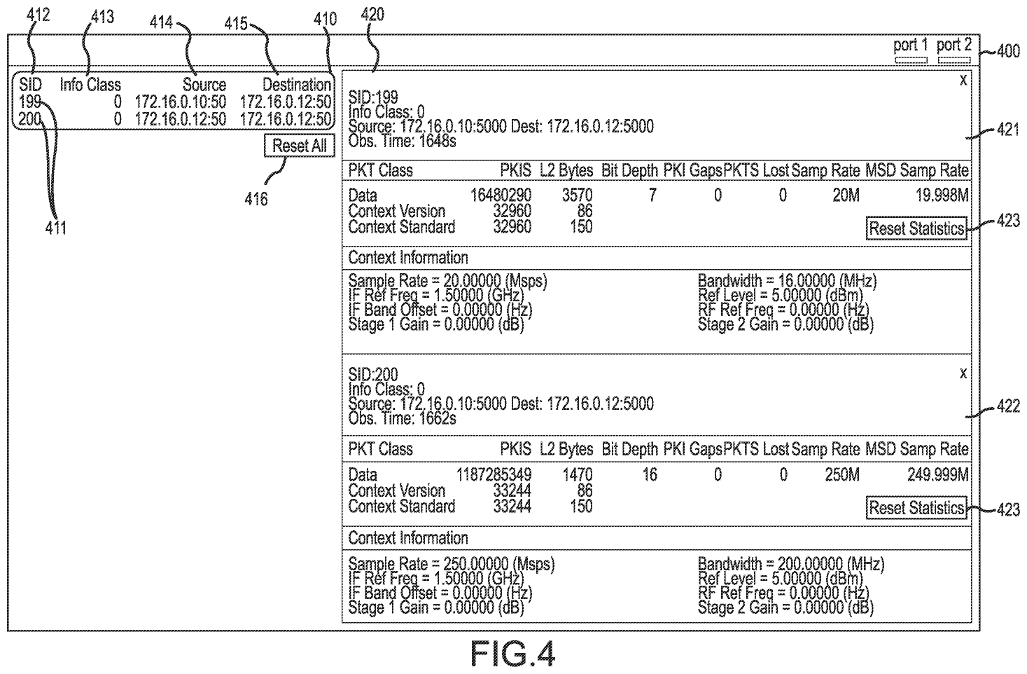

With reference to FIG. 4, a Monitor Page 400 of DIVA's graphical user interface (GUI) displays monitoring information in two panels situated on a single webpage. On the left of the Monitor Page is an Overview Panel 410, and to the right is a Monitor Detail Panel 420. The Overview Panel 410 includes a plurality of rows 411, each of which displays information pertinent to a monitored data stream. A monitored data stream is an individual DIFI information stream that DIVA has observed on the RST network. The user may select for monitoring any DIFI information stream observed by DIVA via a mouse, touchscreen, or other input device. Once selected for observation, detailed information about the is information stream is displayed in the Detail Panel 420.

The Overview Panel 410 includes one or more rows 411, each of which displays information or metrics pertinent to a monitored data stream. A signal identification (SID) column 412 displays the internal tracking number of the monitored data stream, e.g., SID 199 and SID 200 shown here. An Info Class column 413 displays the DIFI Information Class of the information stream. A Source column 414 and a Destination column 415 display the transmitting and receiving IP addresses, respectively, for the data stream. A Reset All command button 416 resets statistics or metrics tracking for all SIDs listed on the SID panel. Resetting the metrics tracking discards previously collected data and allows a user to assemble statistics beginning with the time the button is actuated.

The rows 411 may be labeled and/or color coded based on the status of the DIFI information stream they represent. The colors used for the different statuses may vary as long as the status is reasonably clear and differentiable to the user. NORMAL, which may be shown with white lettering or highlights, is used for DIFI information streams that are active and have no observed errors. INACTIVE, which may be indicated with grey coloration, indicates DIFI information streams that DIVA has previously observed, but have not transmitted additional packets in a past timeout period, which may be, for example, several seconds. DROP, which may be indicated with yellow coloration, indicates DIFI information streams where DIVA has detected dropped packets. ERROR, which may be shown by using red coloration, designates DIFI information streams where DIVA has detected non-compliant DIFI packets. When a particular DIFI information stream has more than one abnormal color condition, the Overview Panel will color code the row according to the following order of precedence: INACTIVE, DROP, then ERROR. A user may dismiss color alerts for INACTIVE and DROP conditions, which returns the row to the NORMAL condition. However, this is a one-time condition dismissal, and if the abnormal condition persists or reoccurs, then the row will change from NORMAL to the appropriate error color. In addition to identifying the type of error condition, DIVA counts the instances of each error and displays the count for user reference.

The Monitor Detail Panel 420 includes one or more windows displaying detailed information for the monitored data streams. In the example shown, information for SID 199 is displayed in the top section 421, and information for SID 200 are displayed in the bottom section 422. Information displayed for each SID include the amount of time the signal has been observed, and categories for three different packet types, i.e., Data Packets, Context Version Packets, and Context Standard Packets. The categories tracked include the number of packets observed, L2 Bytes, bit depth, packet gaps, packets lost, the sampling rate, and the measured sampling rate. These various categories supply useful information for signal monitoring. For example, “L2 Bytes” records a count of the total number of bytes transmitted at the Ethernet layer of the network stack, and “packet gap” tracks when packets in a transmit sequence are missing from an observed sequence. Together, these information categories allow the user to determine the health or fidelity of the observed information stream versus the transmitted information stream. A Reset Statistics command button 423 allows the user to discard previously collected information/metrics for the corresponding SID so that DIVA can collect a new set of statistics beginning with the time of actuation. Context information is extracted from fields in the monitored DIFI context packets and also displayed on the Monitor Detail Panel. Monitored context information includes the signal sample rate, IF reference frequency, IF band offset, stage 1 gain, bandwidth, reference level, RF reference frequency, and stage 2 gain.

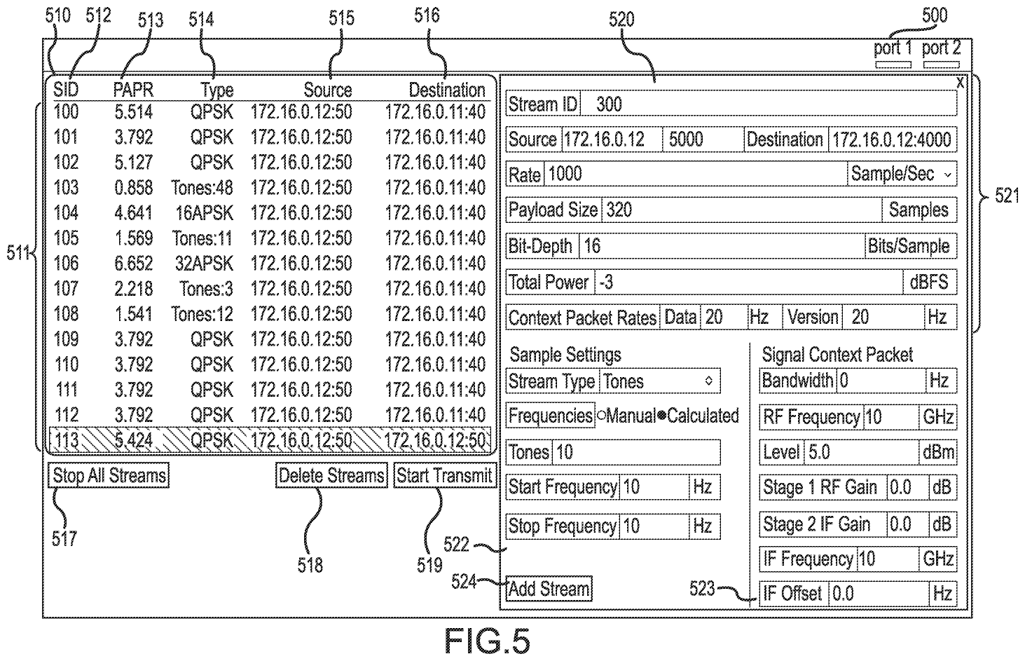

With reference to FIG. 5, the DIVA GUI also includes a Transmit Page 500. On the left of the Transmit Page is a Stream Catalog Panel 510, and to the right is a Stream Builder Panel 520. The Stream Catalog Panel 510 includes a plurality of rows 511, each of which displays an individual test stream entry in the Stream Catalog. The Stream Catalog is a library of test streams available for transmission by DIVA. One or more test streams in the Stream Catalog may be selected and transmitted by DIVA simultaneously as DIFI information streams on the RST network.

Each row includes information about a test stream in the Stream Catalog arranged in columns across the Stream Catalog Panel. A signal identification (SID) column 512 displays the DIFI Packet Stream ID to be assigned to this information stream when the stream is selected for transmission. A peak-to-average power ratio (PAPR) column 513 shows the test signal's PAPR in decibels (dB). A Type column 514 identifies the signal modulation used for payload of test signal packets transmitted in the information stream, e.g., quadrature phase-shift keying (QPSK), amplitude and phase shift keying (APSK), etc. The Type column may also identify the signal as a multitone test signal with the specified number of tones appended to the type. A Source 515 column identifies the Source IP address being used by DIVA, and a Destination column 516 identifies a Destination IP address on the RST network for the receiver. The Stream Catalog Panel also includes three command buttons. A Stop All Streams button 517 halts transmission of all information streams then being transmitted by DIVA. A Delete Streams button 518 removes a highlighted test stream from the Stream Catalog list 511. A Start Transmit button 519 begins transmission of one or more selected streams. Each row 511 in the Stream Catalog Panel 510 is selectable, meaning the user may select one or more test information streams via a mouse, touchscreen, or other input device. Streams selected for transmission are highlighted, as SID 113 is here. Once highlighted, pressing the Start Transmit button begins transmission of the selected stream(s).

New entries in the Stream Catalog list 511 are created by a DIVA user through the Stream Builder Panel 520. Note that created entries are stored in DIVA nonvolatile memory, so they persist after shutdown of the DIVA system. The top section 521 contains text boxes to indicate the characteristics of a test signal as input by the user. Specifically, entries in 521 specify the proposed SID for the new stream, source IP address, destination IP address, DIFI signal payload data Sample Rate (rate), DIFI signal payload size, DIFI signal payload bit depth, the desired signal total power, and context packet rates for data and version packets sent as part of the information stream.

A lower left panel 522 displays additional settings that are dependent on signal type for the sample payload of the information stream under construction. The Stream Type may be Tones to specify a multitone test signal or BPSK, QPSK, 16APSK, or 32APSK to specify parameters for a modulated test signal. Here, sample settings are shown for a test tone signal. Tones specifies the number of tones in the multitone signal. Start Frequency specifies the frequency of the lowest frequency tone, while Stop Frequency specifies the frequency of the highest frequency tone. Tones in the multitone signal are spaced uniformly in frequency with the spacing between tones set to a number equal to the Stop Frequency minus the Start Frequency divided by the number of tones minus 1. A lower right panel 523 displays text boxes with parameters to specify fields in the information stream's signal context packet, including the signal bandwidth, RF frequency, power level, stage 1 RF gain, stage 2 RF gain, IF frequency, and IF offset. Finally, the Stream Builder Panel 520 includes an “Add Stream” command button 524 that allows a user to add the newly created stream to the Stream Catalog.

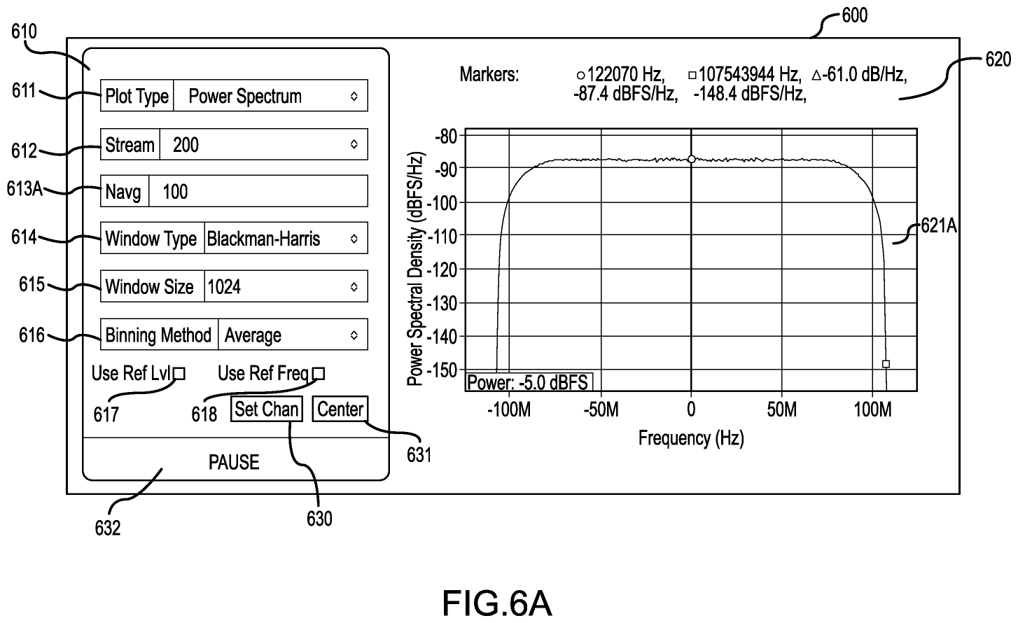

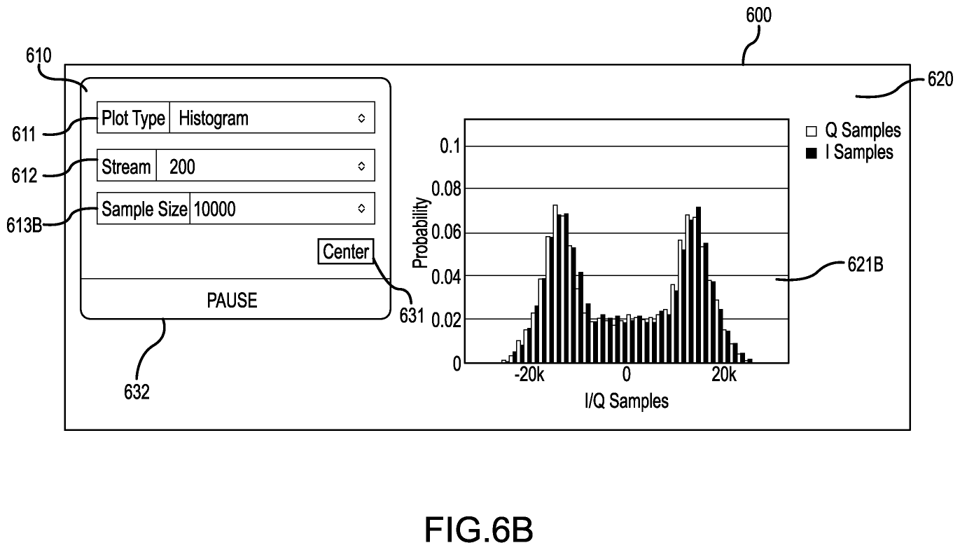

With reference to FIGS. 6A and 6B, the DIVA GUI also includes a Receive Page 600. The Receive Page displays real-time signal analytics for a data stream selected by a DIVA user from among the signals identified on the Monitor Panel. See FIG. 4, item 411. DIVA develops the available signal analytics using signal samples extracted from the selected data stream. With reference to FIG. 6A, on the left of the Receive Page 600 is a Control Panel 610, and on the right is a Graphics Panel 620.

The Control Panel 610 includes fields that can be changed by the user to select the type of analysis displayed on the Graphics Panel 620. A Plot Type field 611 has a dropdown menu for selection of the type of information to be plotted on the Graphics Panel. The menu options include Power Spectrum, showing a plot of power spectral density over a signal bandwidth; Signal Power, showing the signal power in a user-defined band; and Histogram, showing a histogram plot of observed instantaneous signal amplitude. Communication signals have additional signal analytics available through the menu that can be developed by demodulating the communication signal, namely observed signal constellation, and the measured symbol-rate.

Selection of the plot type affects the remainder of the fields available to the user. For example, as shown, a power spectrum plot type is selected, and the corresponding fields are as follows: a Stream field 612 displays the SID for the selected data stream chosen for display, and the dropdown menu allows the user to select from the observed data streams tracked on the Monitor Page. A Navg input text field 613A allows the user to specify the number of periodograms to average to produce the displayed power spectrum trace. A Window Type input text field 614 allows the user to choose the spectral estimation window applied to each periodogram from among the following options: Rectangular, Flattop, Hann, Hamming, Blackman, and Blackman-Harris. A Window Size field 615 allows the user to choose a window size between 64 and 4096. A Binning Method field 616 allows the choice between Average and Positive Peak binning.

A Use Reference Level checkbox 617 can be selected to use the Reference Level from the Signal Context stream in the selected Information Stream 612 to convert the display vertical axis from dBFS/Hz to dBm/Hz. The use reference frequency checkbox 618 can be selected to use the reference IF Frequency from the Signal Context stream in the selected Information Stream 612 to translate the frequency axis for the displayed spectrum from a baseband (zero-centered) frequency representation to an IF Frequency centered representation. The Control Panel includes command buttons as well. A Set Channel button 630 allows the user to specify the band of frequencies, “the channel”, in which the total power will be measured and displayed in the lower left of the power spectrum display. A Center button 631 will return the power spectrum display axis scaling and translation to their original unzoomed values. Finally, the control panels for all Plot Types include a Pause button 632 which alternately freezes and unfreezes the active plot when actuated.

The Graphics Panel 620 shows the plot selected in the Plot Type field 611. Here, an exemplary PSD plot 621A is shown. When selected, the signal analytic is displayed on the Graphics Panel as a live plot that updates periodically as new signal data is gathered from packets in the selected data stream. The displayed plot can be manipulated by a user through mouse, touchscreen, or other suitable input means. For example, the user can use a mouse to zoom in on an area of the plot, or to set markers. When a marker is set, DIVA displays the Power Spectral Density and Frequency for the marked area. If a second marker is set, DIVA also displays the difference in power values between the two markers.

With reference to FIG. 6B, an exemplary Receive Page 600 is shown where a Histogram plot type 611 has been selected. This Control Panel 610 only includes a Stream field 612 for electing the SID of the data stream to monitor, and a Sample Size field 613B. The sample size input text field allows the user to provide the number of samples to produce each displayed histogram. As with other plot displays, a user can manipulate the histogram plot by zooming onto a selected area. A Center command button 631, returns zoomed plots to original zoom level, and a Pause command button 632 stops the display update. The Graphics Panel 620 shows an exemplary histogram plot 621B that plots the estimated probability that instantaneous in-phase and quadrature signals will be found at a given value.

The Receive Page is also configured to display supplementary data streams along with the primary stream selected on the Overview Panel. The Receive Page includes a dropdown menu (not shown) that includes a list of the active DIFI information streams tracked on the Overview Panel. When a supplementary data stream is selected from the dropdown menu, and a signal analytic category for the supplementary stream is selected, the supplementary data stream analytics are displayed on a separate plot alongside the display for the primary data stream. Multiple supplemental signal analytics may be displayed depending on the needs of the user.

### Monitoring of DIFI Information Packets

DIVA is configured to monitor all DIFI information streams carried on an RST network simultaneously, and can identify the source of a data stream based on context data in the various packet streams. DIVA can acquire source data for a given data stream using a VITA 49.2 stream identification number, the Ethernet MAC address, the IP address, or the UDP port. In addition, DIVA supports the address resolution protocol (ARP), allowing it to exchange ARP requests and ARP replies with other devices on the RST network. DIVA's ability to monitor multiple data streams allows a DIVA user to examine packet traffic on an RST network and identify important packet streams.

DIVA's RST NIC is configured to monitor all packet traffic on a connected RST network, not just packets addressed to the DIVA unit. When monitoring a data stream, DIVA first identifies each packet flowing within the stream and labels it as a context packet or a signal packet. Then DIVA tracks the VITA 49.2 Stream ID, MAC address, IP address, and UDP port. Using the source data, DIVA counts the number of packets observed from each packet source and processes the context packets to gather metadata about the stream. Relevant context information collected for each packet stream includes the sample rate and bit-depth for the signal packets flowing within the stream. DIVA also monitors the data streams for errors. Using both the VITA 49.2 header packet sequence number and the packet timestamp, DIVA determines whether and how many packets have been dropped during transmission.

DIVA custom software supplements the VITA 49.2 header packet sequence with an internal timestamp. This is because the VITA 49.2 header packet is only 4 bits long, and may fail to account for a burst of lost packets where the burst length is 16 or greater. Another means for DIVA to monitor information packets not addressed to it is by using the “packet sniffing” capability of a network switch. For example, assume network Node A is a DIFI source, Node-B is a DIFI receiver, and Node C is the DIVA. If the source address for the DIFI packet is Node A and the destination address is Node B, the network switch will complete the primary connection from Node A to Node B. Using the packet sniffing capability of the network switch, a user can create a secondary connection from Node A to the DIVA. This approach allows the DIVA to monitor the traffic from Node A to Node B, and represents the preferred approach to monitoring DIFI traffic in a fielded RST network.

In addition to a DIVA's ability to collect DIFI information streams not addressed to it, DIVA can also receive a data stream directly addressed to it from a single emitter via a direct Ethernet cable connection, through a network switch, or broadcast on the network.

DIVA is configured to identify and construct composite signals from separate DIFI information streams carried on an RST network. A composite signal is a linear combination of two or more frequency-transposed component signals so that the component signals have minimal overlap in frequency within the composite signal. If a composite signal is carried in a given data stream, the DIVA user can select the data stream from the Monitor Page and conduct signal analysis on the Receive Page. Using signal analytics on the Receive Page, the user would select a power spectrum plot to conduct a black space detection analysis. Black-space detection is a process by which the user identifies signal bands that are occupied by a component signal. These component signals are typically carried by a different data stream from the data stream selected on the Monitor Page, which carries the composite signal. Once a component signal is identified, the user can associate the component signal with the SID containing the composite signal.

The association between a candidate component signal and the composite signal may be achieved by one of three approaches. The first approach uses context data for the candidate component data stream and the composite data stream. The user compares the candidate component signal context data, e.g., signal bandwidth, signal symbol rate, and RF Reference Frequency with that of the candidate signal to determine if the component signal is a viable candidate. The criteria for viability include determining whether the candidate signal could fit into detected black space of the composite signal. The second approach is based on correlating signal features for the candidate signal and the composite signal using cyclostationary signal processing methods, as known in the art of signal processing. The third association method is via manual association made by the user observing characteristics of the candidate composite and component signals on the Receive Page.

DIVA annotates viable component signal associations with the composite data stream through the signal power analytic on the Receive Page. Each black space element within the composite signal that has been associated with a component signal is coded with its own designated color. In addition, the SID for component signal associated with the composite signal will appear on the signal power plot in the associated black-space band. This annotation will appear either as text overlaid on the signal power plot, as a pop-up annotation when the user's mouse hovers over the appropriate black-space band, or other suitable annotation.

### DIFI Standard Compliance Certification

In addition to its signal analysis capabilities, DIVA also includes a Compliance Module for assessing whether a device under test (DUT) is able to generate and parse information packets in compliance with the DIFI Standard. DIVA tests a given packet stream at a specified rate that is determined by the sample rate and bit-depth of the signal payload emitted by the DUT, as communicated in the accompanying context packet stream. During the assessment, DIVA maintains a test event database, wherein each entry includes the time of the test, the MAC address of the DUT, as well as the sample rate and bit-depth for the signal payload emitted by the DUT. If DIVA detects any errors, such as dropped packets, during the test event, these are also logged in the database entry for the test event.

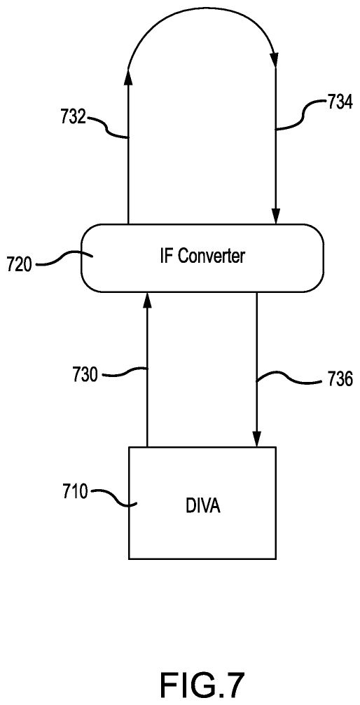

With reference to FIG. 7, DIVA 710 is configured to comprehensively test a DUT's 720 ability to process DIFI information streams by transmitting packet streams 730 to the DUT 720 and receiving processed packets 736 back from the DUT. The testing process may proceed as follows: A user instructs DIVA 710 to prepare and transmit a data stream 730 to the DUT 720. The DUT extracts the signal data from the incoming data stream and prepares an egress packet stream for transmission. The user instructs the DUT to send the transmission packet stream 732, which is transmitted as an analog signal. The analog signal 732 is looped back to the DUT, which receives back its own transmission signal 734 for processing. The DUT parses the transmitted signal 734 and composes DIFI packets 736 for transmission back to DIVA 710. DIVA receives the DUT processed data stream 736 and assesses the stream's compliance with the DIFI Standard. Another testing scenario may proceed as follows: DIVA 710 prepares and transmits a data stream 730 to the DUT 720. Through the DIVA, the user places the DUT into a test mode, and the DUT parses the packet to remove the signal samples, then repackages the samples in a new packet 736 to send back to DIVA 710. DIVA then checks the signal sample and context data in the new packet for DIFI Standard compliance.

To further test the DUT's capabilities, DIVA may optionally instruct the DUT to perform one or more transformations of the data stream. For example, DIVA may instruct the DUT to transmit the DIFI packet with a different bit-depth than the incoming data stream 730. As another example, DIVA may require the DUT to modify the signal data payload by an arithmetic operation, such as addition by a complex-valued constant or multiplication by a complex-valued constant. Such modifications demonstrate that DUT can successfully identify each sample within the payload, and is not performing a bulk-copy of the payload from the incoming packet stream 730 to the transmission packet stream 732.

### Channel Simulation

As disclosed, DIVA is also configured with a Channel Effects module to simulate channel effects to assess the performance of devices under real-world transmission conditions. DIVA applies various channel effects to simulated RF transmission paths between one or more candidate DIFI information stream emitters on an RST network. For example, DIVA may modify a transmission signal by adding pseudo-random noise, signal fading, implementing a random time-varying channel impulse response function, simulating delay and Doppler platform motion, and applying nonlinear effects. To simulate such channel effects, DIVA maintains a unique channel model for devices on the RST network that have been selected by a user for testing.

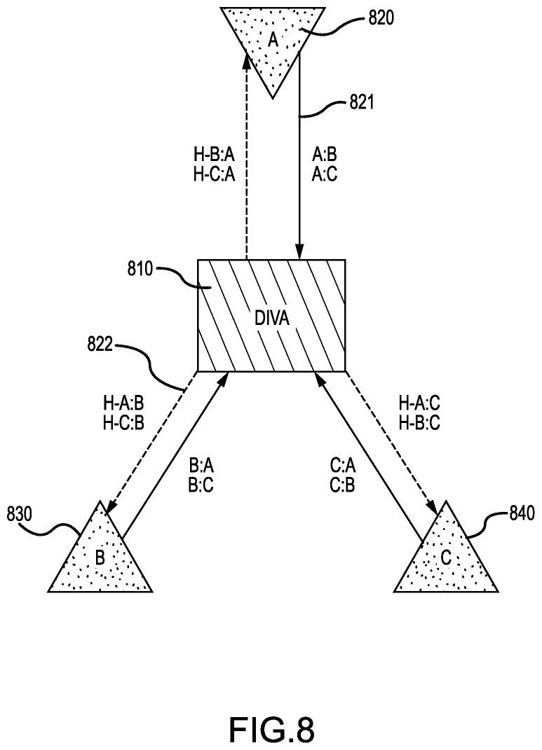

For example, with reference to FIG. 8, a simulated network may consist of three devices, labeled A 820, B 830, and C 840, with DIVA 810 interposing itself in the communication stream between each device on the network. The number of devices and channels DIVA is able to simulate is a matter of signal complexity and DIVA computing capability, however three or more test devices are possible and contemplated.

DIVA implements the simulated network by establishing a unique channel for the data stream flowing from A to B, denoted H-A:B, as well as the other five remaining connections: H-B:A, H-A:C, H-C:A, H-B:C and H-C:B. DIVA applies simulated channel effects to the different signal paths by serving as a relay device between each node. For example, for the simulated signal path A:B, Device A 820 emits a data stream 821 to the DIVA 810, which modifies the signal data from Device A with the simulated channel effects. DIVA then emits a data stream 822 to Device B 830 with the modified signal data, H-A:B, and generates an SID for each data stream used in the simulated network for use on the Monitor Page. Upon reception, Device B processes the modified data stream and may then be instructed by DIVA to retransmit the data stream as processed. Device B's compliance with the DIFI Standard can be assessed based on its fidelity to the DIFI standard and the original data stream 821.

Some channel effects are dependent on the RF or IF frequency of the carrier signal. To simulate such channel effects, DIVA uses the RF or IF reference frequency from the context data carried in the originating data stream. For example, to simulate frequency-dependent channel effects for the connection A:B, DIVA uses context data transmitted by Device A to determine the RF reference frequency. If the simulated channel effect H-A:B is modeled using a frequency transfer function, H_{AB}(f), then H_{AB}(f_{RF}) will be used as the RF reference frequency applied to the signal data from Device A, where f_{RF} is the RF reference frequency identified in the context data transmitted by Device A.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve the manipulation of information elements. Typically, but not necessarily, such elements may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” “words,” “materials,” etc. These specific words, however, are merely convenient labels and are to be associated with appropriate information elements.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

Upon reading this disclosure, those of skill in the art will appreciate still additional alternative structural and functional designs for a system and a process for DIFI packet processing through the disclosed principles herein. Thus, while particular embodiments and applications have been illustrated and described, it is to be understood that the disclosed embodiments are not limited to the precise construction and components disclosed herein. Various modifications, changes, and variations, which will be apparent to those skilled in the art, may be made in the arrangement, operation and details of the method and apparatus disclosed herein without departing from the spirit and scope of the invention.

It will also be understood by those familiar with the art, that the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the disclosed invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the disclosed invention is in no way limited to implementation in any specific programming language, or for any specific operating system or environment.

While there have been described above the principles of the disclosed invention in conjunction with DIFI-compliant information stream processing, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the disclosed invention. The Applicant hereby reserves the right to formulate new claims to such features and/or combinations of such features during the prosecution of the present application or of any further application derived therefrom.

While this invention has been described in terms of several embodiments, there are alterations, modifications, permutations, and substitute equivalents, which fall within the scope of this invention. Although subsection titles have been provided to aid in the description of the invention, these titles are merely illustrative and are not intended to limit the scope of the disclosed invention. In addition, where claim limitations have been identified, for example, by a numeral or letter, they are not intended to imply any specific sequence.

It should also be noted that there are many alternative ways of implementing the methods and apparatuses of the disclosed invention. It is therefore intended that the following appended claims be interpreted as including all such alterations, modifications, permutations, and substitute equivalents as fall within the true spirit and scope of the disclosed invention.

This has been a description of the disclosed invention along with a preferred method of practicing the invention.

What is claimed is:

1. A device, comprising:
a computer processor;
a management network interface card (NIC) controlled by an operating system (OS) for connecting to a network;
a graphical user interface (GUI) for relaying input and output through the management NIC;
a Radio Signal Transport (RST) NIC for connecting to an RST network, and having a first port and a second port, wherein the first port and second port are each configured to process Ethernet frames at a rate of 100 gigabits per second or greater;
an application programming interface (API) configured to control the RST NIC and to manage the processor; and
a software program compatible with the API for composing and parsing Ethernet packets compliant with a standard for transmitting and receiving digitized Intermediate Frequency data and metadata.

2. The device of claim 1, wherein the management NIC routes information for system management, and the RST NIC routes information for packet processing.

3. The device of claim 1, wherein the API manages packet processing outside of the OS.

4. The device of claim 1, wherein the GUI includes a monitor page for displaying information relevant to one or more monitored data streams observed on the RST network, a transmit page for transmitting one or more sample streams from a library, and a receive page for performing analysis on one or more monitored data streams.

5. The device of claim 1, wherein the device is configured to monitor data streams transmitted on the RST network that are one of the following: addressed to the device, not addressed to the device.

6. The device of claim 1, further comprising a compliance module configured to determine if a device under test transmits and receives a data stream compliant with the standard.

7. The device of claim 1, further comprising a channel effects module for simulating one or more channel effects in a data stream.

8. A method comprising:
observing a Radio Signal Transport (RST) network with a device connected though a network interface card (NIC), wherein the NIC is operated by an application programming interface (API) that operates outside of an operating system of the device;
receiving from a user a selected data stream from among data streams transmitted on the RST network;
monitoring the selected data stream;
displaying statistics about the selected data stream including one or more of the following: a packet class, a packet count, a count of Ethernet frame bytes, a bit depth, a gap count, a lost packet count, and a sampling rate.

9. The method of claim 8, further comprising:
receiving from the user an instruction to display a test stream page;
displaying the test stream page listing one or more candidate test streams from a library;
receiving from the user a selected test stream from the library;
transmitting the selected test stream on the RST network.

10. The method of claim 9, further comprising:
receiving from the user a plurality of characteristics of a new test stream;
building the new test stream based on the received characteristics;
receiving from the user a command to add the new test stream to the library; and
adding the new test stream to the library.

11. The method of claim 8, further comprising:
receiving from the user an instruction to perform analytics on the selected data stream;
displaying a signal analytics page;
receiving from the user a selected analytic chosen from among the following: a power spectrum plot, a signal power plot, a histogram plot; and
displaying the selected analytic in a graphics panel.

12. A method for certifying compliance with a standard for transmitting and receiving digitized data, comprising:
connecting a testing device to a Radio Signal Transport (RST) network, wherein the testing device connects to the RST network though a network interface card (NIC) operated by an application programming interface (API), wherein the API operates outside of an operating system of the testing device;
connecting a device under test to the RST network;
instructing the testing device to prepare and transmit a digitized data stream to the device under test;
instructing the device under test to send an analog version of the data stream as a transmission;
looping the transmission back to the device under test as a received transmission;
instructing the device under test to transmit a digitized version of the received transmission to the testing device; and
analyzing, using the testing device, the digitized version for compliance with the standard.

13. The method of claim 12, further comprising:
instructing the device under test to remove signal data from the data stream;
instructing the device under test to transmit a new data stream containing the signal data to the testing device; and
analyzing, using the testing device, the new data stream for compliance with the standard.

14. The method of claim 12, further comprising:
instructing the device under test to modify the data stream;
instructing the device under test to transmit the modified data stream to the testing device; and
analyzing, using the testing device, the modified data stream for compliance with the standard.

15. A method for assessing the performance of digital intermediate frequency communications devices, comprising:
connecting a testing device to a Radio Signal Transport (RST) network, wherein the testing device connects to the RST network though a network interface card (NIC) operated by an application programming interface (API), wherein the API operates outside of an operating system of the testing device;
observing one or more candidate devices on the RST network;
selecting a first test device and a second test device from among the candidate devices;
establishing a simulated network wherein data streams transmitted between the first test device and the second test device are routed through the testing device;
receiving at the testing device a data stream from the first test device;
modifying the data stream;
transmitting a modified data stream to the second test device where the modified data stream is processed for retransmission;
instructing the second test device to transmit the processed data stream to the testing device;
analyzing, using the testing device, the processed data stream for compliance with the standard.

16. The method of claim 15, wherein the testing device is configured to apply one of the following modifications to the data stream: pseudo-random noise, signal fading, time-varying channel impulse response, simulated signal delay, simulated Doppler effects, or non-linear effects.

17. The method of claim 15, further comprising:
selecting a third test device;
establishing a simulated network wherein data streams transmitted among the first test device, the second test device, and/or the third test device are routed through the testing device.

18. The method of claim 15, further comprising:
deriving an RF reference frequency from the data stream; and
applying a frequency-dependent modification to the data stream.
